(19) United States
(12) Patent Application Publication
(10) Pub. No.: US 2023/0014951 A1
(43) Pub. Date: Jan. 19, 2023

(54) A METHOD FOR THE MICROBIAL DISSOLUTION OF ASHES WITH ORGANOMINERAL CONTENT AND A SYSTEM USING THIS METHOD

(71) Applicant: ATATÜRK ÜNIVERSITESI BILIMSEL ARASTIRMA PROJELERI BIRIMI, Yakutiye, Erzurum (TR)

(72) Inventors: Mehmet Nuri AYDOGAN, Yakutiye, Erzurum (TR); Özlem GÜLMEZ, Yakutiye, Erzurum (TR)

(21) Appl. No.: 17/784,568

(22) PCT Filed: Nov. 23, 2021
(86) PCT No.: PCT/TR2021/051271

§ 371 Date: Jun. 10, 2022

(30) Foreign Application Priority Data
Nov. 27, 2020 (TR) 2020/19151

(51) Int. Cl. C05F 17/20; C05B 13/00; C05F 17/40

(52) U.S. Cl. CPC C05F 17/20; C05B 13/00; C05F 17/40

(57) ABSTRACT

Disclosed are a method which provides microbial dissolution of organominerals such as organic wastes or chicken manure ashes burned in thermal power plants and return these ashes to the economy with the goal of zero waste with the created bio products and a system using this method.

### FIELD OF THE INVENTION

The present invention relates to a method for the microbial dissolution of ash with organomineral content and a system using this method.

The present invention particularly relates to a method that provides microbial biodegradation of organominerals such as organic wastes or chicken manure ashes burned in thermal power plants and returns these ashes to the economy with the goal of zero waste with the created bioproducts and a system using this method.

### STATE OF THE ART

Environmental pollution is the most important problem that is increasing in the world and threatening the life of living things if effective measures are not taken. In the existing situation, the wastes of all settlements, especially big cities, are collected in landfills far from the city, and it creates mountains of garbage and from time to time, fires and fatal accidents occur with the explosion of accumulated methane gas without performing any action. Although power plants have been established with methane gas obtained from some solid waste landfills, said solid wastes remain without decaying for many years, creating environmental pollution and emitting bad odors and leakage into groundwater also cause dangerous results. Again in the poultry sector, hundreds of tons of wet manure are produced daily in each farm however, these fertilizers cannot be used directly due to their caustic effects. Particularly, the method of generating electrical energy by burning chicken manure and solid organic wastes, sewage sludge, etc. accumulated in city landfills, and thus the disposal of these wastes is becoming increasingly common in the world. After the said organic wastes are burnt at high temperature, an average of 10-15% mineral-rich ash waste remains in the power plants established for this purpose. However, the minerals present in these organomineral ashes are in the form of insoluble inorganic compounds. In particular, since the calcium rate of chicken manure ash is very high (over 20%), its pH is also very basic (pH=13-14), it is also inconvenient to be released into the environment and is prevented by law as it is not possible to use the same as a fertilizer.

Ash with organomineral content that remains from the burning of organic wastes or chicken manure should be recycled into useful products so as to solve this current problem.

The patent numbered EP2718449B1 encountered in the literature describes a method for processing a lignocellulosic material. A method with the purpose of producing a biofuel comprises the following process steps; wet milling a lignocellulosic material and applying a jet mixer during wet milling; adding an enzyme to the lignocellulosic material after wet milling and adding a microorganism or a sugar derived from the lignocellulosic material to the lignocellulosic material after wet grinding is completed.

Another patent numbered R0129230B1 relates to the use of excess by-products from wood industrialization and sweet whey in the aerobic biodegradation process, without the addition of inorganic synthetic substances so as to obtain an organic fertilizer. Here, the processes of converting hard-to-degrade polysaccharides such as lignin, cellulose and hemicellulose into agricultural organic fertilizers by aerobic biodegradation (with a C/N ratio of 8) are described.

Current patents propose solutions for the recycling of organic waste. There are no specific methods for bioconversion of ashes with organomineral content resulting from the incineration of organic wastes.

As a result, due to the abovementioned disadvantages and the insufficiency of the current solutions regarding the subject matter, a development is required to be made in the relevant technical field.

### BRIEF DESCRIPTION OF THE INVENTION

The present invention relates to use of bioconversion of organomineral ashes which fulfills the abovementioned requirements, eliminate all disadvantages and bring some additional advantages.

The main aim of the invention is to provide a method that provides ashes with organomineral content from burning of various organic wastes and chicken manure to be removed from the waste and converted into useful products through microbial biodegradation (Biological degradation) and bio-solubilization (Biological solubilization) in liquid culture and a system in which this method is used.

Another aim of the invention is to provide easy and low cost disposal of waste ashes. Because tons of waste ash is generated by burning both chicken farm manure and city organic wastes for energy every day. Although the mineral contents of these ashes are rich, the minerals are in insoluble form compounds, the high alkalinity of the ash pH of 13-14 and the fact that they contain some toxic elements do not allow them to be used directly, in this state, they are also inconvenient to be released into the environment and are prevented by legal legislation. Since the ash, which accumulates in increasing amounts every day, cannot be kept in closed areas, it is dispersed by the wind and dispersed around, even if there are suitable storage areas, puts the enterprises in trouble. In this case, the rich organomineral content of the waste ashes cannot be utilized and their stocks lead to a major problem. The materials consisting of the ashes of organic wastes will be completely eliminated by participating in the renewable cycle with the invention and both enterprises and cities will continue to live healthier with a sustainable environment.

Another aim of the invention is to obtain two novel utility products by dissolving the waste ash under suitable conditions in a liquid culture medium by means of mechanisms such as microbial biodegradation (Biological degradation), bio-solubilization (Biological solubilization) and bioaccumulation (Deposition on the biomass).

Another aim of the invention is to use the liquid phase as a mineral basal medium for microorganisms and as a fertilizer for plant growth and development, since the dissolution of the ash in the liquid medium enables the inorganic minerals in the ash passing into the liquid phase as mentioned above.

Another aim of the invention is that the microorganism biomass that provides ash solubility belongs to an edible microorganism with a high protein content and non-toxicity, and this biomass is separated from the liquid and dried and evaluated as an animal feed additive (fish, chicken, chick, etc.).

In order to fulfill the above-described aims, the invention is a method for microbial dissolution of ashes with organomineral content,
determining suitable microorganisms that will dissolve the selected ash with organomineral content, isolating from nature, purifying and storing the same,
preparing inoculum culture by multiplying the microorganism in liquid medium,
preparing medium by adding ash with organomineral content,
adding carbon source into the medium for the growth of microorganisms,
inoculating microorganisms into the prepared medium and subjecting the culture to incubation,
separating biomass (solid phase) and liquid phase formed as a result of incubation,
carrying out toxicity tests for biomass to evaluate its usability as a protein source,
carrying out the mineral analysis for the use of the separated liquid phase as biofertilizer.

In order to fulfill the above-described aims, the invention is a system for microbial dissolution of ashes with organomineral content mainly comprising the following;
an inoculum tank in which the inoculum culture of microorganisms to be transferred into an ash dissolving tank is prepared;
an acid tank containing an acid solution to neutralize the highly alkaline pH in the ash removal tank and to ensure the optimum pH adjustments required in the system;
an ash dissolving tank in which ash is dissolved in the liquid culture medium;

a biomass formation reactor, in which the liquid phase with rich mineral content formed in the ash dissolving tank is transferred, and in which edible single cell protein production is performed.

The structural and characteristic features of the present invention will be understood clearly by the following drawings and the detailed description made with reference to these drawings and therefore the evaluation shall be made by taking these figures and the detailed description into consideration.

### FIGURES CLARIFYING THE INVENTION

FIG. 1 is a schematic view of the inventive system.

The figures are not required to be scaled and the details which are not necessary for understanding the present invention may be neglected. Moreover, the elements that are at least substantially identical or have at least substantially identical functions are shown by the same number.

### DESCRIPTION OF THE REFERENCES

1. Inoculum Preparation Tank
2. Acid tank
3. Molasses (Carbon source) tank
4. Ash dissolving reactor
5. Ash tank
6. Biomass forming reactors
7. Sieves
8. Conveyor belts
9. Mixer motor
10. Air pump
11. Covers
12. Mixers
13. Display and control panel
14. Water inlet
15. Transfer pipes
16. Window
17. Gas outlet pipes
18. Ash channel
19. Discharge channel
20. Heaters
21. Support units
22. Compressor pushing the ash with pressure
23. Carrier channels to the ash dissolving reactor

### DETAILED DESCRIPTION OF THE INVENTION

In this detailed description, the inventive structure is described only for clarifying the subject matter in a manner such that no limiting effect is created.

The invention relates to the microbial dissolution of all ashes with organomineral content, especially chicken manure ashes. As a result of microbial degradation (Biodegradation) and dissolution (Bio-solubilization) in liquid culture, many macro and micro-elements such as potassium, magnesium and iron as well as nitrogen and phosphate in the ash, also become soluble. When the microbial biomass growing in the liquid phase is filtered and separated, the remaining liquid can be used as an organic liquid fertilizer for plant growth and development directly or with simple interventions such as pH adjustment due to its rich mineral content in dissolved form. Furthermore, this liquid fertilizer has the potential to be transformed into different products by means of various manipulations, as well as its use as an effective basal mineral medium in microbial biosynthesis. On the other hand, the microbial biomass part, which is separated from the liquid by filtration, is considered as a single cell protein, provided that it is not toxic, depending on the selection of microorganisms suitable for the purpose.

Within the scope of the invention, the microbial decomposition (Biodegradation) process is carried out on the ashes of organic wastes burned in applications such as thermal power plants mentioned in the state of the art, these ashes, which are rich in various minerals, especially nitrogen, phosphate and potassium, are evaluated as a mineral medium for microorganisms in the prepared liquid culture, while the microorganism incubated and multiplied in this environment enriched with various waste carbon sources, decomposes said ashes and uses the minerals it needs, the mineral excess that it does not use remains in the liquid phase. As a result of incubation, a certain amount of ash in a certain volume dissolves and completely disappears. As a result, a biomass is formed by feeding from the ash in the liquid medium and a liquid phase with rich mineral content is formed.

The biomass formed as a result of the growth of the microorganism and the culture liquid phase enriched in minerals is easily separated from each other by means of filtration or centrifugation. The liquid portion dissolved to a comparable extent with Hoagland's solution; while remaining intact as a plant nutrition solution rich in minerals such as nitrogen, phosphate, potassium, magnesium etc., and the resulting biomass turns into a valuable product that will contribute to animal feed as a rich protein source.

The liquid phase obtained within the scope of the invention is a liquid fertilizer that will support plant nutrition like Hoagland solution and can be used directly in organic agriculture. Therefore, the need for fertilizer in agricultural production will be met organically and the dependence on phosphate fertilizer will be reduced. Since the microorganism used for biodegradation is selected from those whose biomass is edible, biomass is considered as a protein source, that is, as a “single cell protein” with scientific definition. Thus, while achieving zero waste as an environmental target; two important products that support agriculture are achieved.

The invention is a method for microbial dissolution of ashes with organomineral content, comprising the following process steps;
Determining suitable microorganisms that will dissolve the selected ash with organomineral content, isolating from nature, purifying and storing the same,
Preparing vaccine culture by multiplying the microorganism in liquid medium,
Preparing medium by adding ash with organomineral content,
Adding pH adjusting (acid) materials to the medium when other microorganisms that cannot grow in alkaline environments other than carbon source and basophilic or alkali tolerant microorganisms are used for the growth of microorganisms,
inoculating microorganisms into the prepared medium and subjecting the same to incubation,
separating biomass and liquid phase formed as a result of incubation,
carrying out toxicity tests for the use of separated biomass as a protein source,
carrying out the mineral analysis for the use of the separated liquid phase as biofertilizer.

According to an embodiment of the invention, the liquid phase rich in nitrogen, phosphate, potassium, magnesium and other elements can be compared with Hoagland according to the results of mineral analysis or used directly as an organic biofertilizer.

According to an embodiment of the invention, biomass belonging to the transforming microorganism, separated as edible single cell protein (THP), is added to animal feeds as a protein source in certain proportions and toxicity tests are carried out.

In the studies carried out within the scope of the invention, the isolation, purification and storage of suitable microorganisms, which will enable the dissolution of ash with organomineral content in the laboratory environment, has been ensured. Optimization trials were carried out to increase the potential of isolates to dissolve ash. Content analyzes were made and how they could be evaluated was investigated so as to determine the qualities of two products (Liquid and Biomass) formed by the dissolution of ash. A medium-sized (600 L. capacity) reactor was prepared and similar laboratory studies were tested in this reactor so as to test the industrial applicability of the successful results obtained in the laboratory environment in the field. It was observed that the results obtained in the reactor conditions were similar or better than those obtained in the laboratory conditions. The results obtained from the reactor studies were evaluated and a system has been developed for applications to be made in the field, with the technical knowledge of dissolving the tons of ash that comes out every day at the industrial scale and turning it into valuable products with this invention

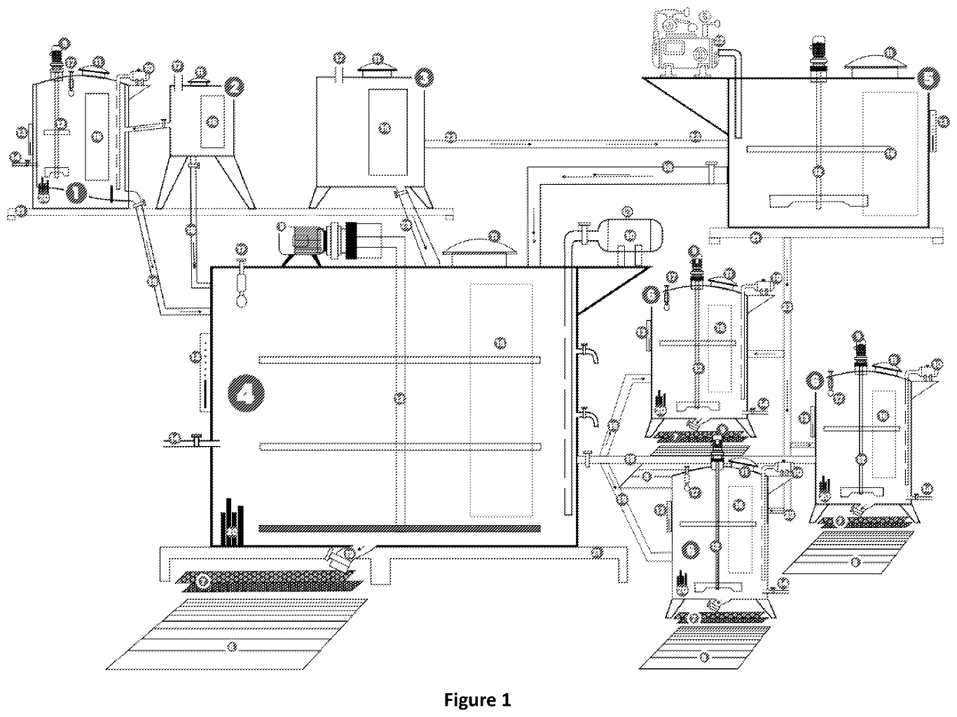

The inventive system for the microbial dissolution of ashes with organomineral-content, whose schematic view is shown in FIG. 1, mainly comprises the following;
at least one inoculum tank (1);
at least one acid tank (2);
at least one molasses tank (3);
at least one ash dissolving tank (4);
at least one ash tank (5);
at least one biomass forming reactor (6).

An inoculum tank (1) is the unit where the inoculum material is prepared by propagating the microorganism to dissolve the ash in a sufficient amount of liquid culture.

Acid tank (2) is the unit that contains materials, preferably acid solution, to neutralize the very alkaline pH in the ash solution tank and to make the necessary optimum pH adjustments in the system.

Molasses (Carbon source) tank (3) is the unit that provides the addition of carbon source (sugar) to all reactors (tanks) where microorganisms are reproduced and used.
Ash dissolving tank (4) is the unit in which ash is dissolved in the liquid culture medium. The ash-dissolving microorganism biomass, which was previously reproduced and prepared in the inoculum tank (1), is transferred to this reactor in sufficient quantity and microbial dissolution of the waste ash is ensured in a certain period of time (2-3 days) by mixing in optimized and suitable conditions.

Ash tank (5) is the unit where the ash to be dissolved is stored. It is the area where the ashes with organomineral content to be subjected to the dissolution process, as the main theme of the whole study, are kept.

Biomass forming reactors (6) are the units in which edible single cell protein is produced in the liquid medium formed by transferring the liquid with rich mineral content formed in the ash dissolving tank (4).

A preferred embodiment of the invention also includes at least one sieve (7). The sieves allow the microorganism mass (biomass) formed in the biomass forming reactors (6) to be separated from the liquid phase by filtration.

A preferred embodiment of the invention also includes at least one conveyor belt (8). It ensures that the biomass formed in the biomass forming reactors (6) is removed from the environment and transferred to the drying unit.

A preferred embodiment of the invention also includes at least one mixer motor (9). It provides movement to the mixers that provide the mixing process required for biomass development and solubility in the biomass forming reactors (6).

A preferred embodiment of the invention also includes at least one air pump (10). It provides air and oxygen to provide the necessary aerobic conditions in the biomass formation process in the reactors.

A preferred embodiment of the invention also includes at least one cover (11). The covers have mechanisms with hinge and lock in suitable dimensions for adding various substances into the reactors and controlling, cleaning, etc. from above.

A preferred embodiment of the invention also includes at least one mixer (12). Mixers provide the necessary homogenization inside the reactors. Mixers with adjustable mixing speed have very important functions in obtaining effective efficiency in biomass development and ash dissolution.

A preferred embodiment of the invention also includes at least one display and control panel (13). It provides adjustment and control of important parameters such as temperature, pH, mixing speed, oxygen transfer.

A preferred embodiment of the invention also includes at least one water inlet (14). Normal drinking or utility water is used in the processes such as liquid culture preparation, washing, cleaning, etc. in reactors.

A preferred embodiment of the invention also includes at least one transfer pipe (15). In the study, these valve pipes are used for liquid or suspension transfers between reactors.

A preferred embodiment of the invention also includes at least one window (16). It allows to physically monitor the developments inside the reactors from the outside and to intervene without delay in case of any negativity.

A preferred embodiment of the invention also includes at least one gas outlet pipe (17). The gases that will occur in the internal volume during operation in the reactors are discharged and explosions that may occur with gas accumulation are prevented.

A preferred embodiment of the invention also includes carrier channels (18) for the ash dissolving reactor. The ash transfer from the ash storage tank (5) to the ash dissolving tank (4), the inoculum material prepared in the inoculum tank (1) and the acid transfer required for pH adjustment are provided through these channels.

A preferred embodiment of the invention also includes at least one discharge channel (19). It provides the discharge of the remaining biomass and undissolved elements after dissolution in the ash dissolving reactor.

A preferred embodiment of the invention also includes at least one heater (20). One of the most important parameters in microbial studies in reactors is temperature. It is a very important apparatus for stabilizing and controlling the temperature at the desired level, and for partial sterilization of reactors before and after incubation.

A preferred embodiment of the invention also includes at least one support unit (21). It is the section that consists of the bases and stabilizer bases of the reactors and tanks that serve as storage.

A preferred embodiment of the invention also includes at least one compressor (22). It provides pressure to push the ash from the ash tank to the ash dissolving reactor through the carrier channel.

A preferred embodiment of the invention also includes molasses (carbon source) transfer channel (23). It provides carbon source transfer to the ash dissolving reactor and biomass forming reactors.

In the system whose schematic view is given in FIG. 1, the essential elements for ash dissolving and product formation are the reactor tanks (1,2,3,4,5,6) that are connected to each other. The Inoculum Tank (1) is used to prepare the inoculum material in an amount to support the operation in industrial reactors of 1-5-10 tons by proliferating the microorganism that will provide ash solubility in a sufficient amount of liquid culture. Acid tank (2) is used to bring the pH of the basic pH ash to a level where the microorganism can proliferate and function. Molasses (Carbon source) tank (3) is the unit that provides the addition of carbon source (sugar) to all reactors (tanks) where microorganisms are proliferated and used. In bioreactors made in different sizes such as 1, 5, 10, 20 Tons depending on the purpose of use in the ash dissolving reactor (4), microbial dissolution of waste ash is ensured in a certain time (2-3 days) with sufficient amount of ash-dissolving microorganism biomass that was previously reproduced and prepared in the inoculum tank. Ash is transferred from the ash tank (5) to the ash dissolving process. Biomass forming reactors (6) are the units in which edible single cell protein production is produced in the liquid medium formed by transferring the liquid with rich mineral content formed in the ash dissolving reactor. Preferred embodiments include said auxiliary units that will enable the inventive method to operate efficiently.

With the system described above, the liquid formed by the microbial dissolubilization of the ashes remaining from the burning of organic wastes and chicken manures, which are used as raw materials, accumulated in solid waste landfills; can be converted into a useful product containing many microelements, especially macro elements such as nitrogen and phosphate and this product can be used directly as a fertilizer in organic agriculture, and it is an important source for the phosphate mineral needed by fertilizer factories. It will meet the foreign dependency in phosphate mineral, which is especially required in agriculture and fertilizer factories of our country. In addition, some organic wastes (molasses and pickle produced in sugar factories, pulp of fruits such as apricot, peach and apple pressed in fruit juice factories, mulberry pulp, grape pulp, canned food, tomato paste factory wastes, dairy whey waste water, etc.) can be evaluated as carbon and nitrogen sources in microbial media in this system. It can be used as a single cell protein (THP) in the biomass formed as a result of the process and thus the zero-waste object is achieved, both a solution to environmental pollution and an important contribution to the economy will be provided.

In the studies carried out by the inventors; the procedure for the isolation, purification, storage of microorganisms that will provide ash solution, and the preparation of liquid cultures and their use in the ash biodegradation process are explained here in the following:

Ash Dissolubilization Stages:

1. ISOLATION and PURIFICATION:

After soil samples are taken from different environments (alkaline, acidic, poor in organic content and rich in organic content) in and around Erzurum and are brought to the laboratory, they are dissolved in sterile physiological water containing 0.9% NaCl and 0.1 ml of these samples are taken, dispersed cultivations were made on selective solid media with added chicken manure ash, which is rich in organomineral content and whose content in terms of important elements is given in Table 1. Each sample was incubated for 24-96 hours at 30° C. and the microorganisms (bacter ia, yeast, fungi) formed at the end of the duration were transferred to separate petri dishes according to their properties

(Nutrient agar, Potato dextrose agar). Analysis results of chicken manure ash in terms of some minerals are given in the following in Table 1.

TABLE 1
Analysis results of chicken manure ash in terms of some minerals

| | Total | | |
|---|---|---|---|
| Total Nitrogen | Phosphorus | Total Potassium | Total Calcium |
| (N) % | (P₂O₅) % | (K₂O) % | (CaO) % |
| 8.1 | 6.5 | 4.5 | 21.8 |

The content and incubation conditions of the selective medium prepared for the isolation of microorganisms that will ensure the solubility of chicken manure ash are given in Table. 2.

Since it is assumed that the organomineral content of the ash is sufficient in terms of macro and microelements and those microorganisms will meet their mineral needs from this environment with the ability to dissolve ash, except for glucose, no other media components were added to the medium in Table 2.

TABLE 2
Selective medium prepared for the isolation of
ash-dissolving microorganisms

| | | | Incubation |
|---|---|---|---|
| Glucose | Ash | Temperature | period |
| (g/L) | (g/L) | (C°) | (Hour) |
| 10 | 20 | 30 | 72 |

2. Selection of the Best Organisms that Provide Ash Biodegradation:

Microorganisms grown in the selective medium were incubated in the same medium at 30° C., at 180 rpm agitation speed, for 72-96 hours. At the end of the incubation period, 4 microbial isolates that had the highest potential to dissolve the ash were selected and these isolates were coded as ASM-1, ASM-2, ASM-7, ASM-9. Passage cultures of these strains (in Petri dishes) were constantly renewed at intervals to be used in future studies. In addition, stock cultures were made and preserved under the necessary conditions (in the refrigerator at +4° C.° and in deep freezer in Eppendorf tubes containing glycerin medium) for later diagnosis and identification.

3. Optimization Studies

Carbon Source Test

Glucose, tea sugar (sucrose) and molasses were used as a carbon source in our study. Each of these was tried in the range of 20-50 g/L in liquid culture and after the best yield was determined as 20 g/L, the use of carbon sources at this level was taken as basis in other trials. Each of the ASM-1, ASM-2, ASM-7, ASM-9 isolates, whose ash dissolving abilities were determined, were incubated in 50 g/L ash medium under appropriate conditions and wet biomass amounts formed at the end of the period are given in Table 3.

TABLE 3
Different carbon sources (Glucose, Sucrose, Molasses) at 20 g/l concentration
and biomass amounts formed in 50 g/L ash medium

| | Amount of wet | Amount of wet | Amount of wet |
|---|---|---|---|
| | biomass formed in | biomass formed in | biomass formed in |
| Microorganism | glucose (20 g/L) | sucrose (20 g/L) | molasses (20 g/L) |
| codes | medium (g) | medium (g) | medium (g) |
| ASM-1 | 80 | 60 | 70 |
| ASM-2 | 96 | 65 | 84 |
| ASM-7 | 110 | 90 | 104 |
| ASM-9 | 98 | 85 | 84 |

Results are the average of 3 repeats. In later studies, molasses was chosen as a carbon source because it is a much cheaper by-product compared to others and optimization studies were continued with ASM-7 coded microorganism (20 g molasses and 50 g ash were used for 1 L in optimization studies).

3.2 pH Test

The pH of the broth prepared with ash varies between 12 and 14. We controlled the amount of biomass and ash dissolution by keeping the pH range between 5 and 10 in our study. Table 4 shows the amount of wet biomass formed at different pH levels in media containing 20 g/L molasses and 50 g/L ash.

TABLE 4
Amounts of wet biomass formed in media containing 20
g/L molasses and 50 g/L ash
Formed biomass amounts (g)

| Microorganism | pH5 | pH7 | PH9 | pH10 |
|---|---|---|---|---|
| ASM-7 | 100 | 85 | 70 | 63 |

3.3. Incubation Period

During our study, all microorganisms developed after 48 hours and the time taken to completely dissolve the ash was determined as 72-96 hours.

3.4. Agitation Speed

Agitation speed is very important for the microorganisms used. The ash dissolving rate decreased visibly at agitation speeds below 180 rpm, while the ash removal rate increased at 180 rpm and above.

3.5. Temperature

In the optimization studies, temperatures of 20, 25 30 and 35° C. were tried and it was determined that the temperature with the best resolution was 25-30° C.

The most suitable pH, temperature, shaking speed, incubation time, type and amount of carbon source for ASM-7 isolate were determined in the optimization studies. The determined optimal conditions are shown in Table 5.

Table 5 the most suitable carbon source and amount, pH, temperature, agitation speed, incubation time, ash amount, determined in optimization studies for ASM-7 isolate.

| Glucose, | | | | Incubation | |
|---|---|---|---|---|---|
| Molasses | | Temperature | Agitation | period | Ash |
| (g/L) | PH | (C. °) | speed (rpm) | (Hour) | (g/L) |
| 20 | 6-7 | 30 | 180-200 | 72-96 | 50 |

When the isolate ASM-7 was used under the specified optimization conditions (20 g molasses, 30° C., pH 6, 180 rpm and 72 hours incubation on time) are applied, 200 g of ash per liter was completely dissolved and 220 g of wet biomass was formed. When dried, 102 g of dry biomass was obtained.

4. Analysis of Liquid Obtained by Dissolving Ash

The liquid and suspended microbial mass (biomass) formed by dissolving the ash microbially under optimal conditions were separated from each other by centrifugation and some analyzes were made for both products. The results of the fluid and biomass analysis performed at Ataturk University Eastern Anatolia High Technology Application and Research Center (DAYTAM) are given in Table 5 and Table 6.

TABLE 5
Analysis results of the liquid formed by the microbial
dissolution of the ash

| Nitrogen | Phosphate | Potassium | Magnesium | Iron (Fe) | Calcium |
|---|---|---|---|---|---|
| (N) ppm | (P) ppm | (K) ppm | (Mg) ppm | ppm | (Ca) ppm |
| 140 | 41.96 | 1258.86 | 291.45 | 3.85 | 91.35 |

The amounts of the elements whose analysis results are seen in the table above (Table 5) in the Hoagland solution taken as reference in plant nutrition are given in the table below (Table 5.1) for comparison.

TABLE 5.1
Amounts of N, P, K, Mg, Fe and Ca in Hoagland solution
referenced in plant nutrition

| Nitrogen | Phosphate | Potassium | Magnesium | Iron (Fe) | Calcium |
|---|---|---|---|---|---|
| (N) ppm | (P) ppm | (K) ppm | (Mg) ppm | ppm | (Ca) ppm |
| 210 | 31 | 234 | 48 | 2.5 | 200 |

Also, the concentration of total organic (sugars, protein, enzymes, hormones, etc. passing through the medium) and inorganic substances dissolved in the liquid obtained by microbial dissolution of ash was determined as 40 g/L by lyophilization (Freeze drying) method.

5. Biomass Analysis

When the biomass which is formed when the microbial solubility of the ash is realized is separated from the liquid phase by centrifugation or filtration, the measurements and some analysis results in terms of said biomass are given in Table 6.

TABLE 6
Measurement and analysis results of biomass formed
as a result of microbial dissolution of ash

| Wet | Dry | Ash | Protein | N by | P by | K by | Mg by | Na by |
|---|---|---|---|---|---|---|---|---|
| weight | weight | ratio | amount | mass | mass | mass | mass | mass |
| g/L | g/L | % | (%) | % | % | % | % | % |
| 220 | 102 | 35 | 9-15 | 1.4 | 5.1 | 2.6 | 2.2 | 0.5 |

6. Necessary processes have been carried out for the diagnosis and identification of the original isolates (ASM-1, ASM-2, ASM-7, ASM-9) obtained as a result of isolation studies carried out so as to ensure the microbial solubility of the ash, respectively they are identified as ASM-1; Phanerochaeta chrysosporium, ASM-2; Trametes versicolor, ASM-7; Rhizoctonia solani and ASM-9 Saccharomyces cerevisia; and code numbers are added to the end of their scientific names. Accordingly, our isolates that we use effectively in ash solubility were named Phanerochaeta chrysosporium ASM-1, Trametes versicolor ASM-2, Rhizoctonia solani ASM-7 and Saccharomyces cerevisia ASM-9.

1. A method for microbial dissolution of ashes with organomineral content, comprising; the following process steps:
determining a suitable microorganisms that will dissolve the selected ash with organomineral content, isolating from nature, purification and storing the same,
preparing inoculum culture by reproducing the microorganism in liquid medium,
preparing medium by adding ash with organomineral content,
adding to the carbon source in to the medium for the growth of microorganisms,
inoculating microorganisms into the prepared medium and subjecting the same to incubation,
separation of biomass and liquid phase formed as a result of incubation,
carrying out toxicity tests to evaluate the usability of biomass as a protein source,
carrying out the mineral analysis of the separated liquid phase its usability as biofertilizer.

2. The method according to claim 1, comprising adding pH adjusting (acid) materials to the medium for these microorganisms which cannot grow in an alkaline environment when microorganisms other than basophilic or alkali-tolerant microorganisms are used in addition to the carbon source for the growth of microorganisms.

3. The method according to claim 1 wherein said microorganisms are Phanerochaeta chrysosporium, Trametes versicolor, Rhizoctonia solani, Saccharomyces cerevisia.

4. A system for microbial dissolution of ashes with organomineral content, characterized by comprising;
an inoculum tank in which the inoculum is prepared by propagating the microorganism to dissolve the ash in a sufficient amount of liquid culture;
an acid tank with an acid solution to neutralize the highly alkaline pH in the ash removal tank and to ensure the optimum pH adjustments required in the system;
an ash dissolving tank in which ash is dissolved in the liquid culture medium;
a biomass formation reactor in which edible single cell protein production is provided in the liquid medium formed by transferring the liquid with rich mineral content formed in the ash dissolving tank.

5. The system according to claim 4, comprising; a molasses (Carbon source) tank that provides the addition of carbon source (sugar) to all reactors (tanks) where microorganisms are reproduced and used.

6. The system according to claim 4, comprising; an ash tank where the ash to be dissolved is stored.
